(19) United States
(12) Patent Application Publication
(10) Pub. No.: US 2018/0185243 A1
(43) Pub. Date: Jul. 5, 2018

(54) APPARATUS FOR DISPENSING A PREDEFINED DOSAGE FORM

(71) Applicants: Vadim ZELIKMAN, Rishon Le-Zion (IL); Zarema ZELIKMAN, Rishon Le-Zion (IL)

(72) Inventors: Vadim ZELIKMAN, Rishon Le-Zion (IL); Zarema ZELIKMAN, Rishon Le-Zion (IL)

(21) Appl. No.: 15/907,554

(22) Filed: Feb. 28, 2018

Related U.S. Application Data
(63) Continuation of application No. PCT/IL2016/050950, filed on Aug. 30, 2016.
(60) Provisional application No. 62/211,871, filed on Aug. 31, 2015.

(51) Int. Cl. A61J 3/02; B02C 19/18; B01F 3/14; B01F 15/00; B01F 7/00

(52) U.S. Cl. CPC A61J 3/02; B02C 19/18; B01F 3/14; B01F 2215/0034; B01F 7/00608; B01F 7/00333; B01F 15/00253

(57) ABSTRACT

An automatic apparatus for dispensing a predefined dosage form, comprising a housing and a pressable means coupled to said housing for activating said apparatus, said housing comprising: a chamber for accommodating a gel based carrier, an inlet for receiving a pharmaceutical composition, a mixing means interconnected with said chamber, motor means for operating said mixing means; and an outlet for dispensing said predefined dosage form. The pharmaceutical composition admixed with said gel based carrier by said mixing means forming and administrating a homogeneous mixture of a predefined dosage form by a single press action on said pressable means.

### CROSS REFERENCE TO RELATED APPLICATIONS

This application is a continuation of PCT Patent Application No. PCT/IL2016/050950 having International filing date of Aug. 30, 2016, which claims the benefit of priority of U.S. Provisional Application No. 62/211,871 filed on Aug. 31, 2015, entitled AN APPARTUS FOR DISPENSING A PREDEFINED DOSAGE FORM. The contents of the above applications are all incorporated by reference as if fully set forth herein in their entirety.

### FIELD OF THE INVENTION

The present invention pertains to apparatuses and methods for preparing a predefined dosage form, more particularly, the present invention pertains to an apparatus for preparing a predefined dosage form comprising a gel based carrier and a pharmaceutical composition.

### BACKGROUND OF THE INVENTION

Several of apparatus and mechanism for mixing pharmaceutical components are known in the art. Several patent documents describe variety of mixing devices and procedures as follows:

US pat. App. No. 2003168538 discloses a process and apparatus for converting tablet type material into a palatable fluid including the steps of placing the tablet type material into the apparatus, having a removable container, and applying automatic tablet disintegrating means to the table material then mixing the disintegrated tablet material with a palatable fluid and discarding or washing the container after the mixture has been ingested.

US pat. App. No. 2004165475 discloses an apparatus for mixing a number of components comprising a vessel for receiving the components, drive means for rotating or oscillating the vessel about an axis to effect mixing of the components within the vessel, and at least one spectroscopic monitoring means for repeatedly scanning the mixture to obtain data for use in monitoring changes in the spectroscopic profile of the mixture as mixing proceeds, the monitoring means by mounted off-axis relative to the axis about which the vessel is rotatable or oscillatable.

PCT publication WO0160503 discloses a mixing apparatus for preparing from a plurality of materials, preferably powders, in particular components of a pharmaceutical composition, a mixture having a required homogeneity, comprising a non-rotating mixing vessel ; at least one feeding mechanism for feeding said materials into said vessel; a stirring means inside said vessel for preparing said mixture; and at least one measuring device for monitoring in-line at one or more locations in said vessel the homogeneity of the mixture being prepared therein, wherein said at least one measuring device comprises a unit for directing input radiation into said vessel, and at least one detector unit for detecting output radiation formed by interaction of said input radiation with said materials in the vessel.

The prior art mentioned above include an administration procedure involves a several steps making it complicated for the user, and there is a relatively high risk of contamination of the drug or the device during the mixing procedure due to the exposure of the surfaces to un-sterile free air and dirt.

It therefore remains a long felt and unmet need to provide novel means and methods for a mixing apparatus which provides predefined dosage of a uniform homogeneity mixture in a more effective and adjustable manner.

### SUMMARY OF THE INVENTION

It is hence one object of the present invention to provide an automatic apparatus for dispensing a predefined dosage form, comprising a housing and a pressable means coupled to the housing for activating the apparatus, the housing comprising:
a. a chamber for accommodating a gel based carrier;
b. an inlet for receiving a pharmaceutical composition;
c. a mixing means interconnected with the chamber;
d. motor means for operating the mixing means; and
e. an outlet for dispensing the predefined dosage form;

wherein the pharmaceutical composition admixed with the gel based carrier by the mixing means forming and administrating a homogeneous mixture of a predefined dosage form by a single press action on the pressable means.

It is another object of the present invention to provide an automatic apparatus for mixing a pharmaceutical composition, comprising:
a. a chamber for accommodating a gel based carrier;
b. a mixing means interconnected with the chamber;
c. motor means for operating the mixing means; and
d. an outlet for the gel based carrier exit, comprising a dose unit;

wherein the pharmaceutical composition admixed with predefined dose of the gel based carrier by the mixing means forming and administrating a homogeneous mixture of a predefined dosage form by a single press action on the pressable means.

It is another object of the present invention to provide an automatic apparatus for preparing a predefined dosage form, comprising a housing and a pressable means coupled to the housing for activating the apparatus, the housing comprising:
a. a first chamber for accommodating a gel based carrier;
b. a mixing means interconnected with the chamber;
c. motor means for operating the mixing means; and
d. a pump system for dispensing the gel based carrier;

wherein the gel based carrier is admixed with a pharmaceutical composition by the mixing means forming and administrating a homogeneous mixture of the predefined dosage form by a single press action on the pressable means.

It is also an object of the present invention to provide the apparatus as mentioned in any of the above, wherein additionally comprising filter means having predefined pore size.

It is also an object of the present invention to provide the apparatus as mentioned in any of the above, wherein the housing additionally comprising a pulverizer assembly for crushing the pharmaceutical composition.

It is also an object of the present invention to provide the apparatus as mentioned in any of the above, wherein the pulverizer assembly is mounted to the mixing element.

It is also an object of the present invention to provide the apparatus as mentioned in any of the above, wherein the pulverizer assembly comprises a first and second arm for griping, squeezing rotating, vibrating, shaking or/and crushing a collecting device comprising the pharmaceutical composition.

It is also an object of the present invention to provide the apparatus as mentioned in any of the above, wherein the housing additionally comprising a dosing unit associated with the gel based carrier chamber; the dosing unit configured to deliver a predetermined quantity of gel based carrier to the mixing chamber.

It is also an object of the present invention to provide the apparatus as mentioned in any of the above, wherein additionally comprising a monitoring means for monitoring and controlling at least one parameter selected from the group consisting of: temperature, dosage, potency, weight, patient identification details and combination thereof.

It is also an object of the present invention to provide the apparatus as mentioned in any of the above, wherein the mixing means is selected from the group consisting of blender, mixer, stirrer, spoon, spiral-like, screw-like and a combination thereof.

It is also an object of the present invention to provide the apparatus as mentioned in any of the above, wherein the mixing means is with a vertical or horizontal spiral motion for pushing the predefined dosage form directly to the outlet.

It is also an object of the present invention to provide the apparatus as mentioned in any of the above, wherein the mixing means is with a vertical or horizontal spiral motion for pushing the carrier directly to the outlet.

It is also an object of the present invention to provide the apparatus as mentioned in any of the above, wherein the housing additional comprising a first passageway tube in fluid communication with the mixing means.

It is also an object of the present invention to provide the apparatus as mentioned in any of the above, wherein the pulverizer assembly is configured to grind, crush, blend, rotate, vibrate, break or/and cut the pharmaceutical composition to a powder form.

It is also an object of the present invention to provide the apparatus as mentioned in any of the above, wherein the apparatus is a portable device for multiple uses.

It is also an object of the present invention to provide the apparatus as mentioned in any of the above, wherein additionally comprising a collecting device selected from the group consisting of a spoon, a cup, a bag, a container and a combination thereof.

It is also an object of the present invention to provide the apparatus as mentioned in any of the above, wherein the pharmaceutical composition is in a solid form or liquid form of a medication, a nutritional supplement, a drug or herbs.

It is also an object of the present invention to provide the apparatus as mentioned in any of the above, wherein the pharmaceutical composition is selected from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof.

It is also an object of the present invention to provide the apparatus as mentioned in any of the above, wherein additionally comprising a second chamber configured for accommodating water and/or salt.

It is also an object of the present invention to provide the apparatus as mentioned in any of the above, wherein the salt is selected from the group consisting of: starch, calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.

It is also an object of the present invention to provide the apparatus as mentioned in any of the above, wherein the gel-based carrier is selected from the group consisting of gellen gum, pregellatinized starch, modified starch, Pionil 1500, GENU GEL SWG-J, Primoj el, GENU pectin, guaiacol, L-HPC(LH-31) L-HPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof.

It is also an object of the present invention to provide the apparatus as mentioned in any of the above, wherein the housing is suitable for customizing a tailor made prescription to fit individual requirements in a dosage form that insures efficacy, swallowability, safety and compliance.

It is also an object of the present invention to provide the apparatus as mentioned in any of the above, wherein the chamber further comprising additives as a palatability improving agents.

It is also an object of the present invention to provide the apparatus as mentioned in any of the above, wherein the apparatus is further configured to prevent contamination, overdosing and non-sanctioned abuse of active ingredient of the pharmaceutical composition.

It is also an object of the present invention to provide the apparatus as mentioned in any of the above, wherein the chamber is configured to accommodate a water capsule and/or a gel based carrier capsule.

It is also an object of the present invention to provide the apparatus as mentioned in any of the above, wherein the housing additionally comprising a syringe configured to inject or/and withdraw a predefined dosage of the gel, water and/or pharmaceutical composition and mixing the gel, water and/or pharmaceutical composition.

It is another of the present invention to provide method of mixing a plurality of components, comprising steps of:
a. introducing a pharmaceutical composition to an automatic apparatus for dispensing a predefined dosage form, comprising a housing and a pressable means coupled to the housing for activating the apparatus, the housing comprising:
   i. a chamber for accommodating a gel based carrier;
   ii. an inlet for receiving a pharmaceutical composition;
   iii. a mixing means interconnected to the chamber;
   iv. rotation means for activating the mixing means and pulverizer assembly;
   v. an outlet for dispensing the predefined dosage form;
b. mixing the gel-based carrier and the pharmaceutical composition by rotating or oscillating the mixing means by a single pressing action thereby, forming a homogeneous mixture of the predefined dosage form.

It is also an object of the present invention to provide the method as mentioned in any of the above, wherein additionally comprising step of dispensing the predefined dosage form in the desired quantity via the outlet.

It is also an object of the present invention to provide the method as mentioned in any of the above, wherein said step of introducing a pharmaceutical composition is by inserting a cup or a container containing the pharmaceutical composition.

It is also an object of the present invention to provide the method as mentioned in any of the above, wherein additionally comprising step of providing a pulverizer assembly for crushing the pharmaceutical composition; the pulverizer assembly is mounted to the mixing element.

It is also an object of the present invention to provide the method as mentioned in any of the above, wherein additionally comprising step of providing a dosing unit associated with the gel based carrier chamber; the dosing unit configured to deliver a predetermined quantity of gel based carrier to the mixing chamber.

It is also an object of the present invention to provide the method as mentioned in any of the above, wherein additionally comprising step of providing a monitoring means for monitoring and controlling at least one parameter selected from the group consisting of: temperature, dosage, potency, patient identification details and any combination thereof.

It is also an object of the present invention to provide the method as mentioned in any of the above, wherein additionally comprising step of selecting the mixing means from the group consisting of blender, mixer, stirrer, spoon, spiral-like, screw-like and a combination thereof.

It is also an object of the present invention to provide the method as mentioned in any of the above, wherein additionally comprising step of providing mixing means having a vertical or horizontal spiral motion for pushing the predefined dosage form directly to the outlet.

It is also an object of the present invention to provide the method as mentioned in any of the above, wherein additionally comprising step of providing mixing means having a vertical or horizontal spiral motion for pushing the carrier directly to the outlet.

It is also an object of the present invention to provide the method as mentioned in any of the above, wherein the housing additional comprising a first passageway tube in fluid communication with the mixing means.

It is also an object of the present invention to provide the method as mentioned in any of the above, wherein additionally comprising step of providing the pulverizer assembly configured to grind, crush, blend, rotate, vibrate, break or/and cut the pharmaceutical composition to a powder form.

It is also an object of the present invention to provide the method as mentioned in any of the above, wherein additionally comprising step of providing a collecting device selected from the group consisting of a spoon, a cup, a bag, a container and a combination thereof.

It is also an object of the present invention to provide the method as mentioned in any of the above, wherein additionally comprising step of providing the pharmaceutical composition is in a solid form or liquid form of a medication, a nutritional supplement, a drug or herbs.

It is also an object of the present invention to provide the method as mentioned in any of the above, wherein additionally comprising step of selecting the pharmaceutical composition from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof.

It is also an object of the present invention to provide the method as mentioned in any of the above, wherein additionally comprising step of providing a second chamber configured for accommodating water and/or salt.

It is also an object of the present invention to provide the method as mentioned in any of the above, wherein the salt is selected from the group consisting of: calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.

It is also an object of the present invention to provide the method as mentioned in any of the above, wherein additionally comprising step of selecting the gel-based carrier from the group consisting of starch, gellen gum, pregellatinized starch, modified starch, Pionil 1500, GENU GEL SWG-J, Primojel, GENU pectin, guaiacol, LHPC(LH-31) L-HPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof.

It is also an object of the present invention to provide the method as mentioned in any of the above, wherein additionally comprising step of providing the chamber further comprising additives as a palatability improving agents.

### BRIEF DESCRIPTION OF THE DRAWINGS

In the following description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

In the accompanying drawing: FIG. 1 presents a perspective view of an apparatus for dispensing a predefined dosage form, of the present invention;

FIG. 2 presents a perspective view of an apparatus for preparing and administrating a predefined dosage form, of the present invention; and

FIG. 3 presents a perspective view of an apparatus for mixing and preparing a predefined dosage form, of the present invention;

FIGS. 4-5 present a perspective view of an apparatus for mixing and preparing a predefined dosage form, of the present invention;

FIG. 6 presents a perspective view of an apparatus for mixing and preparing a predefined dosage form, of the present invention.

### DETAILED DESCRIPTION OF THE PREFERRED EMBODIMENTS

The present invention has been defined specifically to provide a mixing apparatus of a pharmaceutical composition and a gel-based carrier, into a predefined dosage form mixture having a required homogeneity.

The present invention provides an automatic apparatus for dispensing a predefined dosage form, comprising a housing and a pressable means coupled to the housing for activating the apparatus. The housing comprising a chamber for accommodating a gel based carrier, an inlet for receiving a pharmaceutical composition, a mixing means interconnected to the chamber, a pulverizer assembly for crushing the medicament.

The pulverizer assembly is mounted to the mixing means, a motor for activating the mixing means and pulverizer assembly and an outlet for dispensing the predefined dosage form.

The present invention provides an apparatus which provides an improved swallowing dosage form, smell and taste of the medicament it comprises. The apparatus of the present invention does not damage or change the active ingredients content and activity of the medicament.

The apparatus is suitable for customizing a tailor made prescription to fit individual requirements in a dosage form that insures efficacy, swallowability, safety and compliance.

The term ‘pharmaceutical composition’ herein refers to a medicament, medication, drug pharmaceutical formulation, food supplements, dietary elements or minerals or any composition with or without an active ingredient. The pharmaceutical composition may be in a form of an aliquot, tablet, caplet, capsule, pill, bolus, particle, micronized particle, particulate, pellet, core, powder, granule, granulate, small mass, seed, specks, spheres, crystals, beads, agglomerates, nanoparticles and the like.

The pharmaceutical composition may be in a solid or liquid form. The pharmaceutical composition is crushed and mixed with the gel based carrier by the mixing means forming a homogeneous, swallowable mixture of a predefined dosage form by a single action.

In another embodiment of the present invention the apparatus additionally comprising a monitoring means for monitoring and controlling at least one parameter selected from the group consisting of: temperature, dosage, potency, patient identification details and a combination thereof.

The mixing means is selected from the group consisting of blender, mixer, stirrer, spoon, spiral-like, screw-like, screw conveyor, grinder and a combination thereof. The mixing means is with a vertical or horizontal spiral motion for pushing the predefined dosage form via the outlet.

The pulverizer assembly is configured to grind, crush, blend, rotate, vibrate, break, mix or/and cut the pharmaceutical composition to a powder form. The apparatus may be a portable device for multiple uses.

The apparatus is a closed system which further configured to prevent contamination, overdosing and non-sanctioned abuse of active ingredient of the pharmaceutical composition.

In another embodiment of the present invention, the apparatus may comprise a dosing unit associated with the gel based carrier chamber. The dosing unit configured to deliver a predetermined quantity (i.e., a dose) of gel based carrier to the mixing chamber.

Reference is now made to FIG. 1 which illustrates an automatic apparatus for dispensing a predefined dosage form, comprising a housing 1 and a pressable means coupled to the housing for activating the apparatus, the housing comprising: a chamber for accommodating a gel based carrier 4, an inlet for receiving a pharmaceutical composition 2, a mixing means 3 interconnected with the chamber, a motor 6 for operating the mixing means, and an outlet 5 for dispensing the predefined dosage form.

The pharmaceutical composition admixed with the gel based carrier by the mixing means forming and administrating a homogeneous mixture of a predefined dosage form by a single press action on the pressable means.

The mixing means is selected from the group consisting of blender, mixer, stirrer, spoon and a combination thereof. The mixing means is with a vertical or horizontal spiral motion for pushing the predefined dosage form and/or the gel based carrier directly to the outlet.

The housing may additionally comprise a pulverizer assembly for crushing and/or mixing the pharmaceutical composition; the pulverizer assembly may be mounted to a mixing element.

The pulverizer assembly is configured to grind, crush, blend, rotate, vibrate, break or/and cut the pharmaceutical composition to a powder form.

The housing may additionally comprise a monitoring means for monitoring and controlling at least one parameter selected from the group consisting of: temperature, dosage, potency, patient identification details and any combination thereof.

The monitoring mean may further define and correlates between a prepared dosage form and a particular patient by using patient identification details (i.e. payment name, address, date of birth, gender, ID number etc.) stored in the system.

The housing may additionally comprise a first passageway tube in fluid communication with the mixing means.

The apparatus additionally comprising a collecting device selected from the group consisting of a spoon, a cup, a bag, a container and a combination thereof.

The pharmaceutical composition is in a solid form or liquid form of a medication, a nutritional supplement, a drug or herbs.

The pharmaceutical composition is selected from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof.

The apparatus may additionally comprise a second chamber configured for accommodating water and/or salt. The salt is selected from the group consisting of: calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.

The gel-based carrier is selected from the group consisting of starch, gellen gum, pregellatinized starch, modified starch, Pionil 1500, GENU GEL SWG-J, Primojel, GENU pectin, guaiacol, L-HPC(LH-31) L-HPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof.

The chamber may further comprise additives as a palatability improving agents.

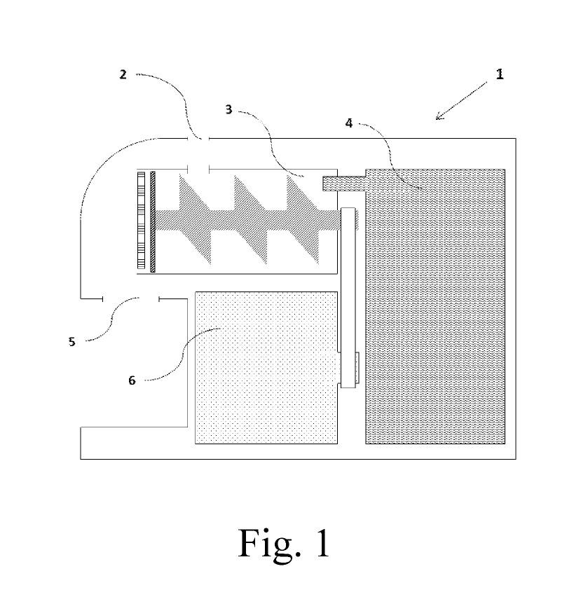

Reference is now made to FIG. 2 illustrating a portable apparatus for mixing a predefined dosage form, comprising: at least one chamber comprising a gel-based carrier(not shown), a mixing means 13, a motor 11 for operating mixing means and a filter or membrane assembly 16 having predefined pores.

The apparatus may further comprise a manual or electric crusher element 12 for crushing grinding or/and mixing the pharmaceutical composition, a medication, a drug, a food supplement and the like having different form and size, with a gel-based carrier.

The chamber further comprises an aperture configured for inserting a pharmaceutical composition, water, solution and any combination thereof.

The apparatus may comprise a pump system configured as a passageway in communication with the inlet.

The apparatus may further comprise a spoon or a stirrer assembly 13 for mixing and/or collecting a predefined dosage form. The spoon may be a disposable spoon.

The apparatus may further comprise a collecting element or device such as a cup, for administrating the prepared dosage form to a patient.

In another embodiment of the present invention the apparatus may comprises a monitoring means for controlling and indicating the dosage, temperature, time, weight, patient identification details and any additional information regarding the device operation and parameters.

The monitoring means may comprise a weight measurement means and/or a predefined aperture size of the outlet for controlling a selected weight or volume of the dosage form when released from the outlet.

The monitoring means may provide an output signal as a visual and/or audible signal for alerting the operator to the fact that the desired degree of mixing, e.g. the homogeneous end point, has been attained so that the operator can then terminate the blending cycle by switching off the drive motor. The signal transmitter may in this instance be provided with a light source for producing a visual output, e.g. a flashing output, and/or a sound source such as a speaker for emitting an audible signal

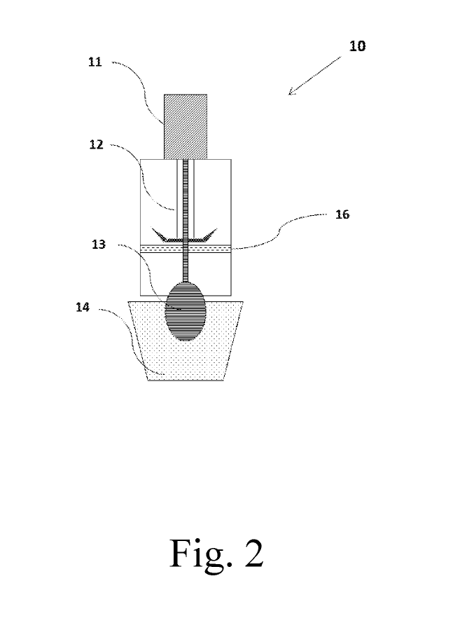

Reference is now made to FIG. 3 illustrating an apparatus for mixing and dispensing a predefined dosage form, comprising: a housing 20 and a pressable means 21 coupled to the housing for activating the apparatus. The housing comprising: a chamber for accommodating a gel based carrier 26, a chamber for accommodating a liquid or a solution 27, a first tube interconnected with the gel base carrier chamber 24a, a second tube in fluid connection with the liquid chamber 24b, a mixing means 25 and crushing means 23, and motor means (not shown) for operating the mixing means.

The pharmaceutical composition may be introduced in a powder form to the collecting devise or a solid unit dosage form which can be crushed by the crushing means and introduced to a collecting device for further mixture with the gel based carrier and water.

In another embodiment of the present invention, the pharmaceutical composition may be crushed in a designated bag placed within the apparatus and then poured to the colleting device.

The pharmaceutical composition admixed with the gel based carrier by the mixing means forming and administrating a homogeneous mixture of a predefined dosage form by a single press action on the pressable means.

A stirring and dispensing mechanism operably associated with the mixing means for stirring the m pharmaceutical composition with a liquid such as water and the gel based carrier.

The outlet is configured to dispense a desired quantity of the gel base carrier.

In another embodiment the present invention may comprise a heated liquid dispensing system for controllably dispensing a desired quantity of heated liquid.

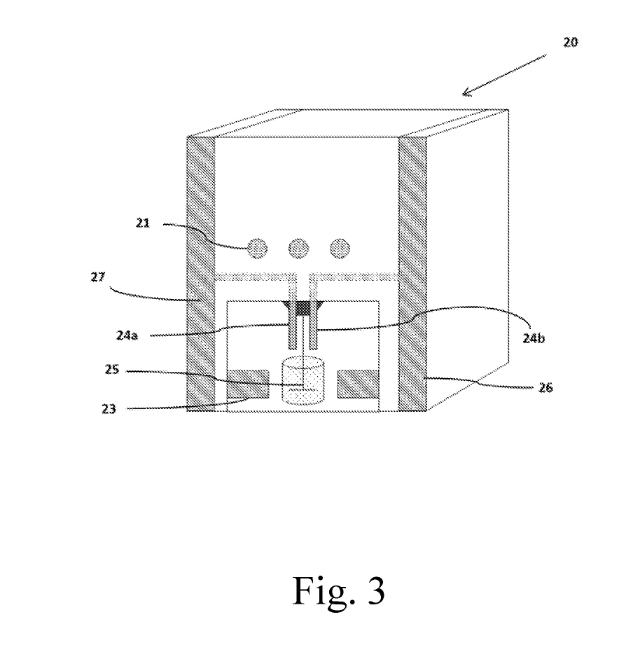

Reference is now made to FIG. 4 illustrating a portable apparatus for mixing a predefined dosage form 30, comprising at least one chamber for accommodating a gel-based carrier container, a mixing means, a pulverizer assembly for crushing a pharmaceutical composition and a motor for operating mixing means and/or a pulverizer assembly. The pulverizer assembly 32 is connected to the outlet portion of the housing.

The pulverizer assembly is configured to grind, crush, blend, rotate, vibrate, break, mix or/and cut the pharmaceutical composition to a powder form.

The mixing means 31 may be also connected to the outlet portion 34 for mixing the gel base carrier and the crushed pharmaceutical composition.

The mixing means is selected from the group consisting of blender, mixer, stirrer, spoon, spiral-like, screw-like, screw conveyor, grinder and a combination thereof. The mixing means may be mounted to tube which delivers the gel based carrier to the collecting devise such as a cup 33.

The apparatus is configured to provide a predefined amount of gel based carrier adjacent to the desired dosage and amount of the pharmaceutical composition.

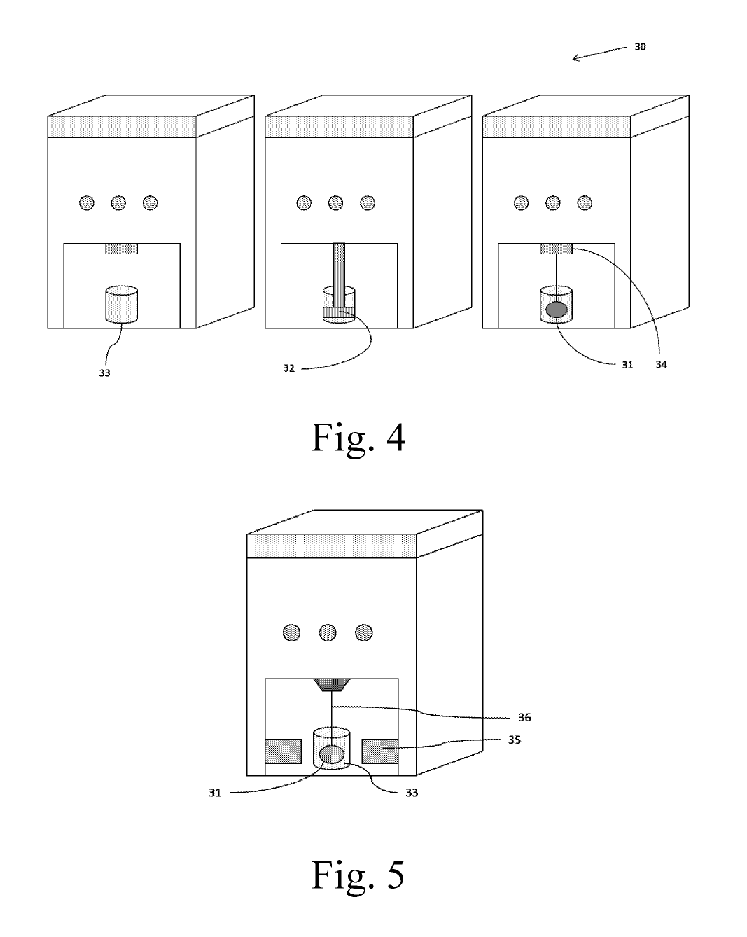

Reference is now made to FIG. 5 illustrating a portable apparatus for crushing and mixing a predefined dosage form, comprising at least one chamber comprising a gel based carrier (not shown), a mixing means 31, a pulverizer assembly 35 for crushing a pharmaceutical composition and a motor for operating mixing means and/or pulverizer assembly. The pulverizer assembly comprises first and second arms for griping, holding squeezing, rotating, vibrating shaking or crushing a collecting device 33 comprising the pharmaceutical composition. The collecting device 33 may be a cup or any container configured for collecting liquid or solid material. The collecting device is composed of a soft, flexible, and stretchable polymer material which can be squeezed or folded by a mechanical force or under the pulverizer mechanical pressure and return to its original shape. The mixing means 31 is connected to the housing via a tube 36 which allows gel based carrier, water or/and pharmaceutical composition to pass through the tube directly to a collecting device.

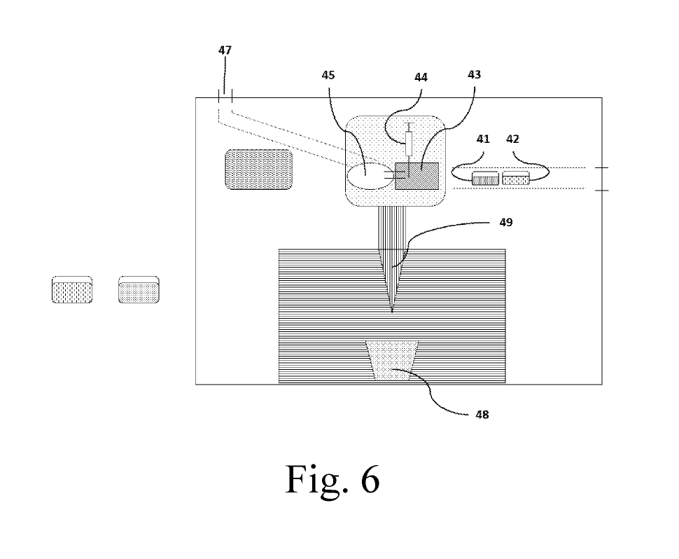

Reference is now made to FIG. 6 illustrating a portable apparatus for mixing a predefined dosage form, comprising at least one chamber 43 for accommodating a gel-based carrier capsule 41 and/or a water capsule 42, a mixing means 44, a motor, a pharmaceutical composition inlet 47 and a pulverizer assembly 45 for crushing a pharmaceutical composition. Use of an ultrasound transmitter for breaking and mixing capsule 41 is also in the scope of the present invention.

The pulverizer assembly is configured to grind, crush, blend, rotate, vibrate, break, mix or/and cut the pharmaceutical composition to a powder form before transferred to the capsules chamber 43.

The mixing means 44 may be a syringe configured to inject fluid into, or withdraw fluid such as a predefined dosage of gel, water, pharmaceutical composition 46 and homogeneous mixture thereof and further mixing gel based carrier, water and/or pharmaceutical composition thereby, forming a homogeneous mixture of the predefined dosage form. The apparatus further comprising an outlet 49 for releasing the mixed dosage form and a collecting device 48 for receiving the mixed dosage form.

The apparatus can be used for a variety of dosage form preparations thereby provides a mixture each time and prevents any contamination, overdosing and non-sanctioned abuse of any of the material been used from one preparation to another.

The present invention further provides a method of mixing a plurality of components, comprising steps of:
a. introducing a pharmaceutical composition to an automatic apparatus for dispensing a predefined dosage form, comprising a housing and a pressable means coupled to the housing for activating the apparatus, the housing comprising:
   i. a chamber for accommodating a gel based carrier;
   ii. an inlet for receiving a pharmaceutical composition;
   iii. a mixing means interconnected to the chamber;
   iv. rotation means for activating the mixing means and pulverizer assembly;
   v. an outlet for dispensing the predefined dosage form;
b. mixing the gel-based carrier and the pharmaceutical composition by rotating or oscillating the mixing means by a single pressing action thereby, forming a homogeneous mixture of the predefined dosage form.

The method additionally comprises step of dispensing the predefined dosage form in the desired quantity via the outlet.

The method additionally comprises step of providing a pulverizer assembly for crushing the pharmaceutical composition. The pulverizer assembly is mounted to the mixing element.

The method additionally comprises step of providing a dosing unit associated with the gel based carrier chamber. The dosing unit configured to deliver a predetermined quantity of gel based carrier to the mixing chamber.

The method additionally comprises step of providing a monitoring means for monitoring and controlling at least one parameter selected from the group consisting of: temperature, dosage, potency, patient identification details and any combination thereof.

The method additionally comprises step of selecting the mixing means from the group consisting of blender, mixer, stirrer, spoon and a combination thereof.

The method additionally comprises step of providing mixing means having a vertical or horizontal spiral motion for pushing the predefined dosage form directly to the outlet.

The method additionally comprises step of providing mixing means having a vertical or horizontal spiral motion for pushing the gel based carrier directly to the outlet.

The method additionally comprises step of providing the housing additionally comprising a first passageway tube in fluid communication with the mixing means.

The method additionally comprises step of providing the pulverizer assembly configured to grind, crush, blend, rotate, vibrate, break or/and cut the pharmaceutical composition to a powder form.

The method additionally comprises step of providing a collecting device selected from the group consisting of a spoon, a cup, a bag, a container and a combination thereof.

The method additionally comprises step of providing the pharmaceutical composition is in a solid form or liquid form of a medication, a nutritional supplement, a drug or herbs.

The method additionally comprises step of selecting the pharmaceutical composition from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof.

The method additionally comprises step of providing a second chamber configured for accommodating water and/or salt.

The method additionally comprises step of selecting the gel-based carrier from the group consisting of starch, gellen gum, pregellatinized starch, modified starch, Pionil 500, GENU GEL SWG-J, Primojel, GENU pectin, guaiacol, L-HPC(LH-31) LHPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof.

The method additionally comprises step of providing the chamber further comprising additives as a palatability improving agents.

1. An automatic apparatus for dispensing a predefined dosage form, comprising a housing and a pressable means coupled to said housing for activating said apparatus, said housing comprising:
a. a chamber for accommodating a gel based carrier;
b. an inlet for receiving a pharmaceutical composition;
c. a mixing means interconnected with said chamber;
d. motor means for operating said mixing means; and
e. an outlet for dispensing said predefined dosage form;
wherein said pharmaceutical composition admixed with said gel based carrier by said mixing means forming and administrating a homogeneous mixture of a predefined dosage form by a single press action on said pressable means.

2. The apparatus according to claim 1, wherein at least one of the following is true:
a. said housing additionally comprises a pulverizer assembly for crushing said pharmaceutical composition;
b. said housing additionally comprises a dosing unit associated with the gel based carrier chamber; said dosing unit configured to deliver a predetermined quantity of gel based carrier to the mixing chamber;
c. said apparatus comprises a monitoring means for monitoring and controlling at least one parameter selected from the group consisting of: temperature, dosage, potency, weight, patient identification details and combination thereof;
d. said mixing means is selected from the group consisting of blender, mixer, stirrer, spoon, spiral-like, screw-like and a combination thereof;
e. said mixing means is connected to said housing via a tube which allows the passage of said gel based carrier, water or/and pharmaceutical composition directly to a collecting device;
f. said mixing means is with a vertical or horizontal spiral motion for pushing said predefined dosage form directly to said outlet;
g. said mixing means is with a vertical or horizontal spiral motion for pushing said carrier directly to said outlet;
h. said housing additional comprising a first passageway tube in fluid communication with said mixing means; and
i. said pulverizer assembly is configured to grind, crush, blend, rotate, vibrate, break or/and cut said pharmaceutical composition to a powder form.

3. The apparatus according to claim 1, wherein at least one of the following is true:
a. said apparatus is a portable device for multiple uses;
b. said apparatus comprises a collecting device selected from the group consisting of a spoon, a cup, a bag, a container and a combination thereof;
c. said pharmaceutical composition is in a solid form or liquid form of a medication, a nutritional supplement, a drug or herbs;
d. said pharmaceutical composition is selected from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof;
e. said apparatus comprises a second chamber configured for accommodating water and/or salt;
f. said gel-based carrier is selected from the group consisting of starch, gellan gum, pregellatinized starch, modified starch, Pionil 1500, GENU GEL SWG-J, Primojel, GENU pectin, guaiacol, L-HPC(LH-31) L-HPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof;
g. said housing is suitable for customizing a tailor made prescription to fit individual requirements in a dosage form that insures efficacy, swallowability, safety and compliance; said chamber further comprising additives as a palatability improving agents;
h. said apparatus is further configured to prevent contamination, overdosing and non-sanctioned abuse of active ingredient of said pharmaceutical composition;
i. said chamber is configured to accommodate a water capsule and/or a gel based carrier capsule;
j. said housing additionally comprising a syringe configured to inject or/and withdraw a predefined dosage of said gel, water and/or pharmaceutical composition and mixing said gel, water and/or pharmaceutical composition.

4. The apparatus according to claim 2, wherein at least one of the following is true:
a. said pulverizer assembly is mounted to said mixing element; and
b. said pulverizer assembly comprises a first and second arm for griping, squeezing rotating, vibrating, shaking or/and crushing a collecting device comprising said pharmaceutical composition;
c. said pulverizer assembly comprises an ultrasound transmitter.

5. The apparatus according to claim 1, wherein said salt is selected from the group consisting of: calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.

6. An automatic apparatus for mixing a pharmaceutical composition, comprising:
a. a chamber for accommodating a gel based carrier;
b. a mixing means interconnected with said chamber;
c. motor means for operating said mixing means; and
d. an outlet for said gel based carrier exit, comprising a dose unit;
wherein said pharmaceutical composition admixed with predefined dose of said gel based carrier by said mixing means forming and administrating a homogeneous mixture of a predefined dosage form by a single press action on said pressable means.

7. The apparatus according to claim 6, wherein additionally comprising filter means having predefined pore size.

8. The apparatus according to claims 6, wherein at least one of the following is true:
a. said housing additionally comprises a pulverizer assembly for crushing said pharmaceutical composition;
b. said housing additionally comprises a dosing unit associated with the gel based carrier chamber; said dosing unit configured to deliver a predetermined quantity of gel based carrier to the mixing chamber;
c. said apparatus comprises a monitoring means for monitoring and controlling at least one parameter selected from the group consisting of: temperature, dosage, potency, weight, patient identification details and combination thereof;
d. said mixing means is selected from the group consisting of blender, mixer, stirrer, spoon, spiral-like, screw-like and a combination thereof;
e. said mixing means is connected to said housing via a tube which allows the passage of said gel based carrier, water or/and pharmaceutical composition directly to a collecting device;
f. said mixing means is with a vertical or horizontal spiral motion for pushing said predefined dosage form directly to said outlet;
g. said mixing means is with a vertical or horizontal spiral motion for pushing said carrier directly to said outlet;
h. said housing additional comprising a first passageway tube in fluid communication with said mixing means; and
i. said pulverizer assembly is configured to grind, crush, blend, rotate, vibrate, break or/and cut said pharmaceutical composition to a powder form.

9. The apparatus according to claim 6, wherein at least one of the following is true:
a. said apparatus is a portable device for multiple uses; t
b. said apparatus comprises a collecting device selected from the group consisting of a spoon, a cup, a bag, a container and a combination thereof;
c. said pharmaceutical composition is in a solid form or liquid form of a medication, a nutritional supplement, a drug or herbs;
d. said pharmaceutical composition is selected from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof;
e. said apparatus comprises a second chamber configured for accommodating water and/or salt;
f. said gel-based carrier is selected from the group consisting of starch, gellan gum, pregellatinized starch, modified starch, Pionil 1500, GENU GEL SWG-J, Primojel, GENU pectin, guaiacol, L-HPC(LH-31) L-HPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof;
g. said housing is suitable for customizing a tailor made prescription to fit individual requirements in a dosage form that insures efficacy, swallowability, safety and compliance; said chamber further comprising additives as a palatability improving agents;
h. said apparatus is further configured to prevent contamination, overdosing and non-sanctioned abuse of active ingredient of said pharmaceutical composition;
i. said chamber is configured to accommodate a water capsule and/or a gel based carrier capsule;
j. said housing additionally comprising a syringe configured to inject or/and withdraw a predefined dosage of said gel, water and/or pharmaceutical composition and mixing said gel, water and/or pharmaceutical composition.

10. The apparatus according to claim 8, wherein at least one of the following is true:
a. said pulverizer assembly is mounted to said mixing element; and
b. said pulverizer assembly comprises a first and second arm for griping, squeezing rotating, vibrating, shaking or/and crushing a collecting device comprising said pharmaceutical composition;
c. said pulverizer assembly comprises an ultrasound transmitter.

11. The apparatus according to claim 9, wherein said salt is selected from the group consisting of: calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.

12. An automatic apparatus for preparing a predefined dosage form, comprising a housing and a pressable means coupled to said housing for activating said apparatus, said housing comprising:
a. a first chamber for accommodating a gel based carrier;
b. a mixing means interconnected with said chamber;
c. motor means for operating said mixing means; and
d. a pump system for dispensing said gel based carrier;
e. wherein said gel based carrier is admixed with a pharmaceutical composition by said mixing means forming and administrating a homogeneous mixture of said predefined dosage form by a single press action on said pressable means.

13. The apparatus according to claim 12, wherein at least one of the following is true:
a. said housing additionally comprises a pulverizer assembly for crushing said pharmaceutical composition;
b. said housing additionally comprises a dosing unit associated with the gel based carrier chamber; said dosing unit configured to deliver a predetermined quantity of gel based carrier to the mixing chamber;
c. said apparatus comprises a monitoring means for monitoring and controlling at least one parameter selected from the group consisting of: temperature, dosage, potency, weight, patient identification details and combination thereof;
d. said mixing means is selected from the group consisting of blender, mixer, stirrer, spoon, spiral-like, screw-like and a combination thereof;
e. said mixing means is connected to said housing via a tube which allows the passage of said gel based carrier, water or/and pharmaceutical composition directly to a collecting device;
f. said mixing means is with a vertical or horizontal spiral motion for pushing said predefined dosage form directly to said outlet;
g. said mixing means is with a vertical or horizontal spiral motion for pushing said carrier directly to said outlet;
h. said housing additional comprising a first passageway tube in fluid communication with said mixing means; and
i. said pulverizer assembly is configured to grind, crush, blend, rotate, vibrate, break or/and cut said pharmaceutical composition to a powder form.

14. The apparatus according to claim 12, wherein at least one of the following is true:
a. said apparatus is a portable device for multiple uses; t
b. said apparatus comprises a collecting device selected from the group consisting of a spoon, a cup, a bag, a container and a combination thereof;
c. said pharmaceutical composition is in a solid form or liquid form of a medication, a nutritional supplement, a drug or herbs;
d. said pharmaceutical composition is selected from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof;
e. said apparatus comprises a second chamber configured for accommodating water and/or salt;
f. said gel-based carrier is selected from the group consisting of starch, gellan gum, pregellatinized starch, modified starch, Pionil 1500, GENU GEL SWG-J, Primojel, GENU pectin, guaiacol, L-HPC(LH-31) L-HPC(LH-21), Avicel RC-591NF, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives such as: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and mixtures thereof;
g. said housing is suitable for customizing a tailor made prescription to fit individual requirements in a dosage form that insures efficacy, swallowability, safety and compliance; said chamber further comprising additives as a palatability improving agents;
h. said apparatus is further configured to prevent contamination, overdosing and non-sanctioned abuse of active ingredient of said pharmaceutical composition;
i. said chamber is configured to accommodate a water capsule and/or a gel based carrier capsule;
j. said housing additionally comprising a syringe configured to inject or/and withdraw a predefined dosage of said gel, water and/or pharmaceutical composition and mixing said gel, water and/or pharmaceutical composition.

15. The apparatus according to claim 13, wherein at least one of the following is true:
a. said pulverizer assembly is mounted to said mixing element; and
b. said pulverizer assembly comprises a first and second arm for griping, squeezing rotating, vibrating, shaking or/and crushing a collecting device comprising said pharmaceutical composition;
c. said pulverizer assembly comprises an ultrasound transmitter.

16. The apparatus according to claim 14, wherein said salt is selected from the group consisting of: calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.

17. A method of mixing a plurality of components, comprising steps of:
a. introducing a pharmaceutical composition to an automatic apparatus for dispensing a predefined dosage form, comprising a housing and a pressable means coupled to said housing for activating said apparatus, said housing comprising:
i. a chamber for accommodating a gel based carrier;
ii. an inlet for receiving a pharmaceutical composition;
iii. a mixing means interconnected to said chamber;
iv. rotation means for activating said mixing means and/or pulverizer assembly;
v. an outlet for dispensing said predefined dosage form;
b. mixing said gel-based carrier and said pharmaceutical composition by rotating or oscillating said mixing means by a single pressing action thereby, forming a homogeneous mixture of said predefined dosage form.

18. The method according to claim 17, wherein at least one of the following is true:
a. said step of introducing a pharmaceutical composition is performed by means of inserting a cup or a container containing said pharmaceutical composition;
b. said method comprises A step of dispensing said predefined dosage form in the desired quantity via said outlet;
c. said method comprises a step of providing a pulverizer assembly for crushing said pharmaceutical composition; said pulverizer assembly is mounted to said mixing element;
d. said method comprises a step of providing a dosing unit associated with the gel based carrier chamber; said dosing unit is configured to deliver a predetermined quantity of gel based carrier to the mixing chamber;
e. said method comprises a step of providing a monitoring means for monitoring and controlling at least one parameter selected from the group consisting of: temperature, dosage, potency, weight, patient identification details and a combination thereof; and
f. said method comprises a step of selecting said mixing means from the group consisting of blender, mixer, stirrer, spoon, spiral-like, screw-like and a combination thereof.

19. The method according to claim 17, wherein at least one of the following is true:
a. said method comprises a of providing mixing means having a vertical or horizontal spiral motion for pushing said predefined dosage form directly to said outlet;
b. said method comprises a step of providing mixing means having a vertical or horizontal spiral motion for pushing said carrier directly to said outlet;
c. said housing additional comprising a first passageway tube in fluid communication with said mixing means;
d. said method comprises a step of providing said pulverizer assembly configured to grind, crush, blend, rotate, vibrate, break or/and cut said pharmaceutical composition to a powder form;
e. said method comprises a step of providing a collecting device selected from the group consisting of a spoon, a cup, a bag, a container and a combination thereof;
f. said method comprises a step of providing said pharmaceutical composition is in a solid form or liquid form of a medication, a nutritional supplement, a drug or herbs;
g. said method comprises a step of selecting said pharmaceutical composition from the group consisting of: aliquot, tablet, caplet, capsule, pill, bolus, particle, micronized particle, particulate, pellet, core, powder, granule, granulate, small mass, seed, specks, spheres, crystals, beads, agglomerates, nanoparticles or any combination thereof;
h. said method comprises a step of providing a second chamber configured for accommodating water and/or salt.

20. The method according to claim 19, wherein said salt is selected from the group consisting of: calcium sulfate, sodium chloride, potassium sulfate, sodium carbonate, lithium chloride, tripotassium phosphate, sodium borate, potassium bromide, potassium fluoride, sodium bicarbonate, calcium chloride, magnesium chloride, sodium citrate, sodium acetate, calcium lactate, magnesium sulfate, alkali metal chlorides, sodium fluoride, organic acids such as citric, succinic, fumaric, malic, maleic, glutaric, lactic and the like; alkali metal sulfates such as sodium sulfate; dihydrogen sodium phosphate, monohydrogen sodium phosphate, disodium hydrogen phosphate, and mixtures thereof, and multivalent metal cations.
